(19) United States
(12) Patent Application Publication
(10) Pub. No.: US 2021/0073393 A1
(43) Pub. Date: Mar. 11, 2021

(54) ENCRYPTION FOR MACHINE LEARNING MODEL INPUTS

(71) Applicant: KAZUHM, INC., San Diego, CA (US)

(72) Inventors: Joshua Owen JACOBSON, San Diego, CA (US); Rounak Prasad KULKARNI, San Diego, CA (US)

(21) Appl. No.: 16/564,527

(22) Filed: Sep. 9, 2019

(51) Int. Cl. G06F 21/60; G06N 3/08

(52) U.S. Cl. CPC G06F 21/602; G06N 3/08

(57) ABSTRACT

Aspects of the present disclosure provide methods and systems for training a neural network. Embodiments include determining a symmetric key that indicates a scrambled ordering of data components. Embodiments include receiving a plurality of training data instances. Embodiments include training a neural network by, for each respective training data instance of the plurality of training data instances: identifying a training input and a training output of the respective training data instance; identifying a plurality of training input components of the training input; providing the plurality of training input components to an input layer of the neural network based on the scrambled ordering indicated by the symmetric key; receiving an output from the neural network in response to the plurality of training input components; and determining whether to modify one or more parameters of the neural network based on the output and the training output of the respective training data instance.

### INTRODUCTION

Aspects of the present disclosure relate to systems and methods for secure processing related to data used with machine learning models, such as neural network-based models.

Computing is increasingly ubiquitous in modern life, and the demand for computing resources is increasing at a substantial rate. Organizations of all types are finding reasons to analyze more and more data to their respective ends.

Many complimentary technologies have changed the way data processing is handled for various users and organizations. For example, improvements in networking performance and availability (e.g., via the Internet) have enabled organizations to rely on cloud-based computing resources for data processing rather than building out dedicated, high-performance computing infrastructure to perform the data processing. The promise of cloud-based computing resource providers is that such resources are cheaper, more reliable, easily scalable, and such resources do not require any high-performance on-site computing equipment. However, cloud-based computing exposes organizations to certain challenges and risks, such as data custody and privacy.

For example, many organizations rely on cloud-based computing resources and other off-site computing resources to perform processing related to machine learning models. However, inputs to machine learning models often consist of personally identifiable information (PII), such as medical images, facial features, identification numbers, financial account numbers, or audio samples, to name a few, which is used by data processors (also referred to as model servers) to make the useful inferences regarding the input data. Utilizing encryption in transit can prevent unwanted disclosure of such information between the provider and the processor of the data, but once the data is at the processor, it is out of the control of the provider. Worse, the processor may misrepresent its security capabilities or misunderstand its security obligations with respect to the data. Even in the best case, a provider may nevertheless be compromised from internal and external nefarious actors. Even in environments where processing occurs locally (i.e. within a certain security boundary), the potential risk of managing multiple copies of sensitive data as it is used in various stages of modeling and inferencing is significant.

Accordingly, systems and methods are needed to enable secure processing of data related to machine learning models.

### BRIEF SUMMARY

Certain embodiments provide a method for training a neural network. In one implementation, the method includes: determining a symmetric key that indicates a scrambled ordering of data components; receiving a plurality of training data instances; and training a neural network by, for each respective training data instance of the plurality of training data instances: identifying a training input and a training output of the respective training data instance; identifying a plurality of training input components of the training input; providing the plurality of training input components to an input layer of the neural network based on the scrambled ordering indicated by the symmetric key; receiving an output from the neural network in response to the plurality of training input components; and determining whether to modify one or more parameters of the neural network based on the output and the training output of the respective training data instance.

Other embodiments provide a non-transitory computer-readable medium comprising instructions to perform the method described above for training a neural network. Further embodiments provide an apparatus configured to perform the method described above for training a neural network.

The following description and the related drawings set forth in detail certain illustrative features of one or more embodiments.

### BRIEF DESCRIPTION OF THE DRAWINGS

The appended figures depict certain aspects of the one or more embodiments and are therefore not to be considered limiting of the scope of this disclosure.

FIG. 1 depicts an example of symmetric key encryption for neural network inputs.

FIG. 2 depicts an example of using a symmetric key to map input components to nodes of an input layer of a neural network.

FIG. 3 depicts an alternate embodiment of using a symmetric key to map input components to nodes of an input layer of a neural network.

FIG. 4 depicts example operations for training a neural network based on input data encrypted using a symmetric key.

FIG. 5 depicts example operations for using a neural network based on input data encrypted using a symmetric key.

FIG. 6 depicts a computing system that may be used to perform methods described herein.

FIG. 7 depicts an embodiment of a distributed computing resource management system in which methods described herein may be performed.

To facilitate understanding, identical reference numerals have been used, where possible, to designate identical elements that are common to the drawings. It is contemplated that elements and features of one embodiment may be beneficially incorporated in other embodiments without further recitation.

### DETAILED DESCRIPTION

Aspects of the present disclosure provide apparatuses, methods, processing systems, and computer readable mediums for secure processing of data related to machine learning models. In some implementations, symmetric key encryption is used to secure data used with models such as neural network models.

Processing related to machine learning models, such as neural networks, often involves sensitive information, such as personally identifiable information (PII) and other confidential data. For example, a neural network may be trained to recognize medical conditions based on medical imaging data, such as CT scan images. Due to the confidential nature of such data, there are security risks associated with performing neural network processing, particularly when the processing is performed by third-party computing resources, such as cloud computing resources.

In order to improve upon conventional techniques, which may just secure data in transit between parties, techniques described herein involve using an encryption key (e.g., a symmetric key) to “embed” an encryption scheme into a machine learning model by training the model to accept inputs that have been scrambled based on the encryption key.

Symmetric key encryption generally refers to techniques in which the same cryptographic key is used to encrypt unsecured data and to decrypt secured data. In certain embodiments of the present disclosure, a symmetric key is generated that specifies an order in which components of an input data item are to be provided to an input layer of the model. The symmetric key is used to scramble inputs to the model both during training and when using the trained model to create inferences. Because the model is trained to accept inputs in the scrambled order, the symmetric key does not need to be provided to any components that perform model processing. For example, the model can be deployed to third parties, such as cloud service providers, which can process encrypted input data without the need for the encryption key. This beneficially reduces the risk of processing sensitive data both onsite and offsite. Further, it allows for the already encrypted data to be sent over network connections without the need for additional encryption processing (e.g., TLS/SSL), which may beneficially improve the speed of transmission and reception of data between entities both internal and external to a data provider.

### Example of Symmetric Key Encryption for Neural Network Inputs

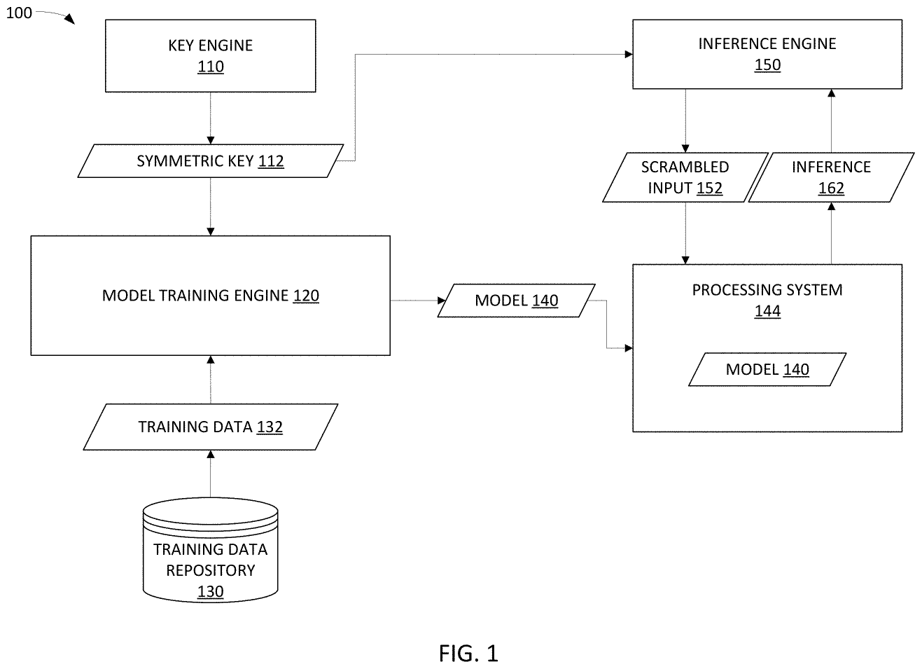

FIG. 1 depicts an example 100 of using encryption in a machine learning model deployment. In particular, in this example, symmetric key encryption is utilized with a neural network model, but in other examples, alternative forms of encryption and machine learning models may be implemented.

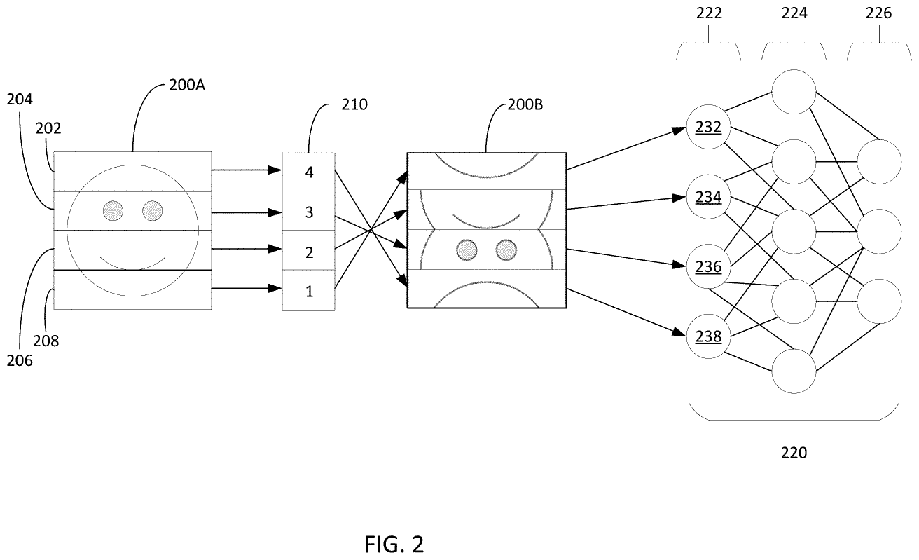

Example 100 includes a key engine 110, which generates encryption keys, such as symmetric keys, for use in training and using machine learning models. In some embodiments, key engine 110 runs on an onsite computing device, such as node 232a of FIG. 2, which is described in more detail below with respect to FIG. 2.

In this embodiment, key engine 110 generates symmetric key 112, which may be used to determine an order for providing input components to model 140, both during training and when using model 140. In some embodiments, a length of symmetric key 112 is determined based on a number of inputs in an input layer of model 140.

For example, symmetric key 112 may be a series of n values, where n is the number of inputs in the input layer of model 140 and where each of the n values indicates a target input of the input layer. In certain embodiments, each given value of the n values (e.g., the i^{th} value) of symmetric key 112 is a unique number between 0 and n, and indicates which input in the input layer the i^{th} input component is provided to.

In another example, symmetric key 112 has fewer values than the number of inputs in the input layer of model 140, and is iteratively applied to subsets of the input components until all input components are scrambled. For example, if symmetric key 112 has x values, then the input components may be sequentially divided into subsets of x, and the symmetric key may be used to scramble the ordering of the input components in each subset.

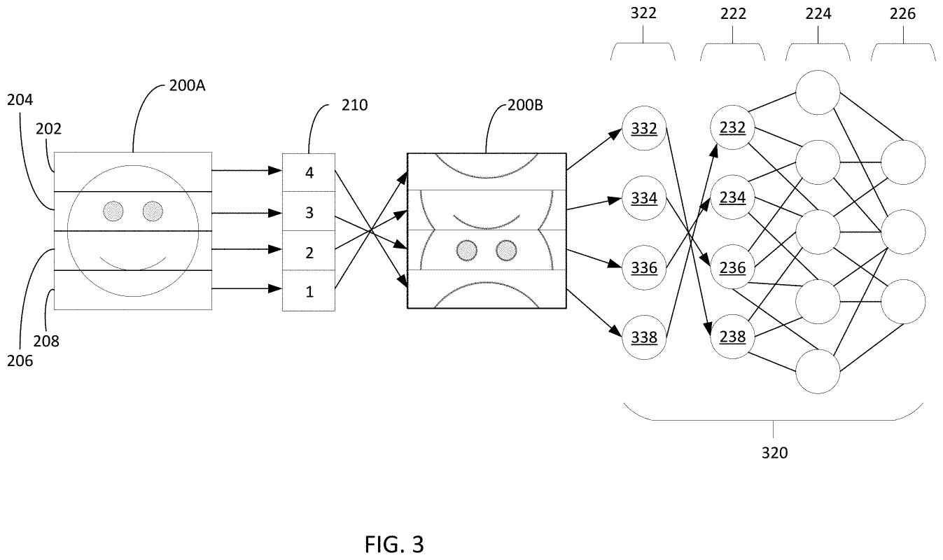

As further described below with respect to FIG. 3, key engine 110 may verify a security level of symmetric key 112, such as by providing symmetric key 112 to a verification component. A security level of symmetric key 112 generally indicates whether input components that have been scrambled using symmetric key 112 can be reconstructed by the verification component without using symmetric key 112. In some embodiments, the security level is a binary value indicating whether or not symmetric key 112 is secure. If symmetric key 112 is determined not to be secure, then a different symmetric key may be generated.

Key engine 110 is configured to provide symmetric key 112 to model training engine 120 and inference engine 150.

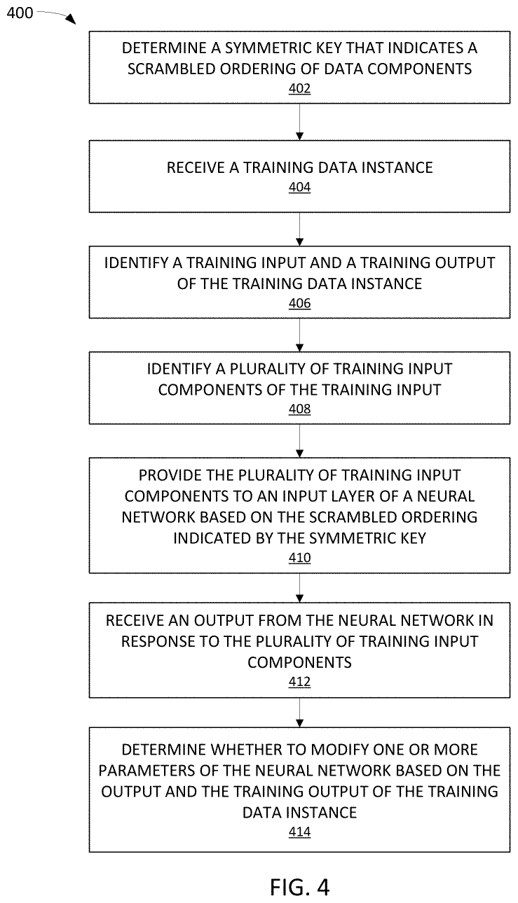

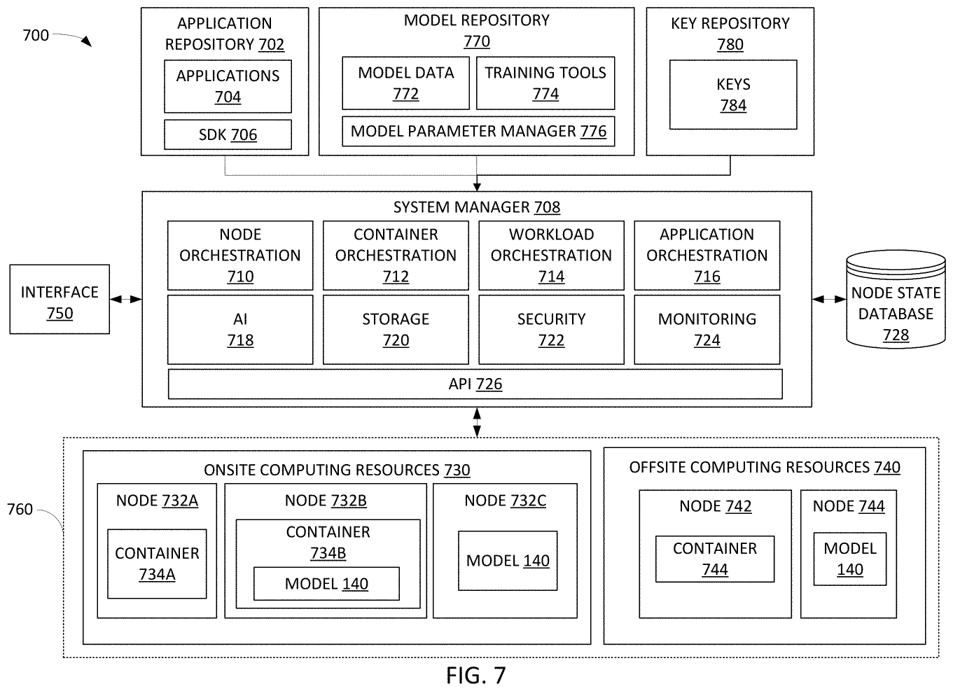

Model training engine 120, which may be a part of training tools 774 of FIG. 7, performs operations related to training model 140, such as operations 400 of FIG. 4, described below. Model training engine 140 may run on an onsite computing device, such as node 232B of FIG. 2, as described below with respect to FIG. 2. In certain embodiments, model training engine 120 receives training data 132 from training data repository 130, and uses training data 132 and symmetric key 112 to train model 140.

Training data repository 130 represents a data store in which training data is maintained. Training data 132 may be used as inputs to an input layer of model 140 and may be labeled so as to test the performance of model 140. Training data 132 can include various types of data depending on the nature of model 140. For instance, if model 140 is an image-recognition model, then training data 132 may include images as training inputs and labels indicating entities that are present in the images.

In certain embodiments, model 140 is a neural network. Neural networks generally include a plurality of connected units or nodes called artificial neurons, loosely modeling the neurons in a biological brain. Each node generally has one or more inputs with associated weights, a net input function, and an activation function. Nodes are generally included in a plurality of connected layers, where nodes of one layer are connected to nodes of another layer, with various parameters governing the relationships between nodes and layers and the operation of the neural network.

In certain embodiments, training a neural network involves providing training inputs to nodes of an input layer of the neural network. The neural network processes the training inputs through its various layers and outputs inferences. The inferences are compared to the labels associated with the training inputs to determine the accuracy of the neural network, and parameters of the neural network are iteratively adjusted until the inferences produced by the neural network based on the training inputs match the labels associated with the training inputs. Parameters adjusted during training may include, for example, gradient descent hyperparameters, such as learning rate, loss function, mini-batch size, number of training iterations, momentum, etc. Parameters may also include model hyperparameters, such as number of hidden nodes, weight decay, activation sparsity, nonlinearity, weight initialization, random seeds and model averaging, and preprocessing input data. Parameters may also include hyperparameters related to parameter space exploration, including coordinate descent, grid search, random search, and model-based optimization methods.

Model training engine 120 uses symmetric key 112 to determine an order for providing components of a given training input of training data 132 to nodes of an input layer of model 140. For example, if the given training input is an image, symmetric key 112 may be used to determine an order for providing pixels of the image to nodes of the input layer of model 140. As illustrated and described in more detail below with respect to FIG. 3, symmetric key 112 may indicate a mapping between each component of the training input (e.g., each pixel of an image, each row or column of an image, each character of a string, each portion of an audio file, or the like) and each node of the input layer of model 140 such that the components of the training input are provided in a scrambled order to model 140. This is done for every training input in training data 132 so that model 140 is trained to accept and process inputs in the scrambled order indicated by symmetric key 112.

While some embodiments involve using symmetric key 112 to provide inputs in a scrambled order to the standard input layer of model 140, alternative embodiments involve adding an additional input layer to model 140. For example, if a model has already been trained without using symmetric key encryption, an additional input layer may be added to the trained model in order to accept inputs in a scrambled order based on symmetric key 112. In these alternative embodiments, a first input layer of model 140 (e.g., an added or additional input layer) accepts inputs in the scrambled order, and each node of the first input layer is mapped to a respective node of a second or original input layer, which is now no longer an input layer but a hidden layer, based on symmetric key 112 such that the mappings between the first input layer and the second input layer “unscramble” the scrambled inputs. For example, if symmetric key 112 indicates that input component A is provided as an input to node C of the first input layer, then node C of the first input layer will be mapped to node A of the second input layer. Because the second “input layer” actually becomes a hidden layer of the model when the first input layer is added as the outward-facing layer of the model, only the scrambled inputs provided to the first input layer are visible outside the model, while the unscrambled inputs provided to the second input layer are hidden within the model. As such, this alternative embodiment may be used to provide security for inputs to an already-trained model, such as in cases where re-training the model using symmetric key encryption techniques described herein is prohibitively expensive or difficult due to constraints of a particular organization.

Once training is complete, model training engine 120 provides model 140 to processing system 144. Processing system 144 may, for instance, be an offsite computing resource, such as a remote or cloud processing entity, as described below with respect to FIG. 7. In one embodiments, processing system 144 corresponds to node 744 of FIG. 7. While example 100 depicts model 140 being provided to a single processing system 144, other embodiments involve providing parts of model 140 to different processing systems, such as providing each layer of model 140 to a different processing system.

Inference engine 150 performs operations related to using model 140 to determine inferences. Inference engine 150 receives symmetric key 112 from key engine 110, and uses symmetric key 112 to provide scrambled input 152 (e.g., based on an input received from an application, as described below) to model 140 on processing system 144.

For example, inference engine 150 may receive an input, such as an image from an application, identify components of the input, such as pixels of the image, and, based on symmetric key 112, determine a scrambled order for providing the components to the input layer of model 140 on processing system 144. As such, neither the original input (unscrambled) nor symmetric key 112 are provided to processing system 144. This technique ensures the security of any sensitive data included in the input while still allowing for the use of offsite computing resources such as processing system 144 to perform processing related to model 140.

In some embodiments, inference engine 150 runs on an onsite computing device, such as node 232C of FIG. 2, as described in more detail below with respect to FIG. 2.

Processing system 144 returns an inference 162 output by model 140 to inference engine 150. Continuing with the image as an input example, inference 162 may comprise a label indicating one or more entities detected in the input image. Because model 140 was trained based on training inputs that were scrambled according to symmetric key 112, it is able to accurately process scrambled input 152 and output an accurate inference 162 despite the scrambled nature of the input. In some embodiments, inference engine 150 then provides inference 162 to an application from which it received the input.

Advantageously, techniques described herein allow models to be run on various processing systems without exposing input data to security risks inherent in conventional techniques (e.g., providing unscrambled inputs to models, thereby exposing the unscrambled inputs to the processing system on which the model runs). According to embodiments of the present disclosure, the components of scrambled input 152 have been scrambled such that their original, unscrambled form is not accessible without symmetric key 112, and so processing system 144 is able to process the input using model 140 to produce inference 162 without having access to the original, unscrambled input.

### Example Encryption of Input Data to Neural Network Model

FIG. 2 depicts an example encryption of input data to a neural network model based on a symmetric key. For example, FIG. 2 may represent a scrambled order in which input components are provided to nodes of an input layer of model 140 of FIG. 1 based on a symmetric key generated by key engine 110 of FIG. 1, both by model training engine 120 during a training stage and by inference engine 150 of FIG. 1 after training is complete.

An input 200A comprises a plurality of input components 202, 204, 206, and 208 (which may be representative of a larger number of input components). In one embodiment, input 200A is a training input, while in another embodiment, input 200A is an input provided to model 140 of FIG. 1 after training is complete. While input 200A is an image in this example, techniques described herein may also be implemented with other types of images, such as audio, text, or another type of data. Input components 202, 204, 206, and 208 are depicted as segments of the image, but may also be representative of pixels of an image, characters of text, segments of audio, or the like. In one example, input 200A is an x-ray image, and input components 202, 204, 206, and 208 represent segments of the x-ray image. In alternative embodiments, input 200A may represent a vector with dimensions 202, 204, 206, and 208.

Model 220 is a neural network comprising an input layer 222, a hidden layer 224, and an output layer 22. In some embodiments, model 220 is representative of model 140 of FIG. 1. Input layer 222 comprises a plurality of nodes 232, 234, 236, and 238, each of which accepts an input component of input 200A.

In one example, model 220 is a neural network that performs image recognition, such as for x-ray images or other types of medical images.

Symmetric key 210 may be representative of symmetric key 112 of FIG. 1, and is used to determine scrambled ordering 200B for providing input 200A to input layer 222. For instance, the length of symmetric key 210 may be based on the number of input components 202, 204, 206, and 208 in input 200A (e.g., n=4 in this example), where a position in the symmetric key indicates an input component and a value in the position indicates an input layer node to which it is mapped. As shown, the first value of symmetric key is 4, so the first component 202 of input 200A is provided to the fourth node 238 of input layer 222. The second value of symmetric key 210 is 3, so the second component 204 of input 200A is provided to the third node 236 of input layer 222. The third value of symmetric key 210 is 2, so the third component 206 of input 200A is provided to the second node 234 of input layer 222. The fourth value of symmetric key 210 is 1, so the fourth component 208 is provided to node 238 of input layer 222.

It is noted that this is only included as a simple example of a symmetric key, and alternative types of symmetric keys may be used.

FIG. 2 represents a first embodiment in which input components are provided in a scrambled order to a standard input layer 222 of a model 220. As described below with respect to FIG. 3, other embodiments involve including an additional input layer in the model, thereby making the original input layer a hidden layer.

FIG. 3 depicts an alternative embodiment in which an additional input layer 322 is added to model 220 of FIG. 2 to produce model 320. The additional input layer 322 includes a plurality of nodes 332, 334, 336, and 338. With input layer 322 being the outward facing layer of model 320, layer 222 becomes a hidden layer. For example, model 320 may be used in cases where training has already been completed without using symmetric key encryption but security of inputs to the trained model is still desired.

As shown, node 332 is mapped to node 238, node 334 is mapped to node 236, node 336 is mapped to node 234, and node 338 is mapped to node 238. The mappings between input layer 322 and hidden layer 222 may, for instance, be determined based on symmetric key 210.

For example, symmetric key 210 may be used to reverse the mappings between input 200A and input layer 322 in the mappings between input layer 322 and hidden layer 222 such that hidden layer 222 reproduces the original ordering of input 200A. In some embodiments, input layer 220 is not publicly accessible in order to preserve the security of input 200A. As such, only the scrambled version of the input is provided to the input layer 322 that is accessible outside the model.

### Example Methods Related to Symmetric Key Encryption for Neural Network Inputs

FIG. 4 depicts example operations 400 for training a neural network based on a symmetric key. In some embodiments, operations 400 are performed by model training engine 120 of FIG. 1.

Operations 400 begin at step 402, where a symmetric key is determined that indicates a scrambled ordering of data components. In some embodiments, model training engine 120 of FIG. 1 receives the symmetric key from key engine 110 of FIG. 1, which may have generated the symmetric key. A length of the symmetric key may, in some cases, be based on a number of components of an input layer of a neural network. In other embodiments, the length of the symmetric key is fixed, and is applied to subsets of input components to determine a scrambled ordering.

In some cases, model training engine 120 or key engine 110 of FIG. 1 verifies a security level of the symmetric key. The security level of the symmetric key may be verified in a variety of ways, such as by scrambling a sample input using the symmetric key to produce a scrambled sample input and then providing the scrambled sample input to a security verification component that attempts to determine the sample input based on the scrambled sample input without using the symmetric key. If the security verification component is able to determine the sample input based on the scrambled sample input without using the symmetric key, then the symmetric key may be considered to be of an insufficiently high security level, and an alternative symmetric key may be generated. If the security verification component is unable to determine the sample input based on the scrambled sample input without using the symmetric key, then the symmetric key may be considered to be of a sufficiently high security level.

Operations 400 then proceed to step 404, where a training data instance is received. In some embodiments, the training data instance is received by model training engine 120 of FIG. 1 from training data repository 130 of FIG. 1.

Operations 400 then proceed to step 406, where a training input and a training output of the training data instance are identified. In some embodiments, the training input is an example item of data, such as an image, text, or audio, associated with one or more labels that are the training output. For example, the training input may have been labeled with the training output in advance.

Operations 400 then proceed to step 408, where a plurality of training input components of the training input are identified. In some embodiments, the plurality of training input components are subsets of the training input. In one example, the training input is an image and the training input components are pixels of the image.

Operations 400 then proceed to step 410, where the plurality of training input components are provided to an input layer of a neural network based on the scrambled ordering indicated by the symmetric key. In some embodiments, model training engine 120 of FIG. 1 determines the scrambled ordering for providing the training input components to the input layer of the model 140 of FIG. 1 based on the symmetric key as described above with respect to FIG. 3A. The input layer may include a plurality of nodes, and each training input component may be provided to a different node.

In some embodiments, the neural network includes an additional input layer, and the nodes of the input layer are mapped to nodes of the additional input layer based on the symmetric key. For example, the mappings from the input layer to the additional input layer may reverse the scrambled ordering indicated by the symmetric key. The input layer may be generated based on the symmetric key such that the nodes of the input layer are mapped to nodes of the additional input layer in a reverse of the scrambled ordering indicated by the symmetric key.

Operations 400 then proceed to step 412, where an output is received from the neural network in response to the plurality of training input components. In some embodiments, model training engine 120 of FIG. 1 receives an inference as an output from model 140 of FIG. 1. The inference may be output by the final layer or output layer of model 140 of FIG. 1.

Operations 400 then proceed to step 414, where it is determined whether to modify one or more parameters of the neural network based on the output and the training output of the training data instance. In some embodiments, model training engine 120 of FIG. 1 trains model 140 of FIG. 1 by iteratively modifying parameters of model 140 of FIG. 1 until its output in response to the training input matches the training output. For example, the output may be compared to the training output, and various parameters such as weights, connections, number of hidden nodes, weight decay, activation sparsity, nonlinearity, weight initialization, random seeds, model averaging, preprocessing input data, coordinate descent, grid search, random search, and model-based optimization methods, may be modified such until the output matches the training output. In some embodiments, this process is performed for a plurality of training data instances in order to train the neural network.

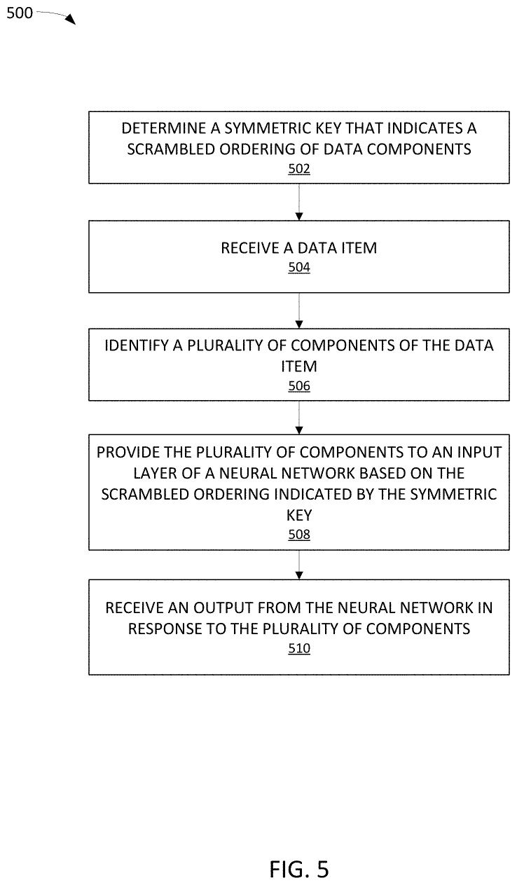

After the neural network is trained, the symmetric key is used to determine an order for providing input components to the neural network, as described in more detail below with respect to FIG. 5.

In some embodiments, various aspects of operations 400 are performed in a distributed computing environment such as heterogeneous distributed computing resource management system 200 of FIG. 2. For example, key generation and training operations may be performed using on-site computing resources, while aspects of the neural network may be distributed to a plurality of off-site processing components for distributed processing, the symmetric key not being provided to the plurality of off-site processing components.

In some examples, a new symmetric key is determined that indicates a new scrambled ordering, and the neural network is re-trained based on the new symmetric key and the training data instance (or, in some cases, a plurality of training data instances). In alternative embodiments involving an additional input layer, a new symmetric key only requires modifying the input layer of the neural network based on the new symmetric key so that the mapping from the input layer to the additional input layer reflects a reversal of a new scrambled ordering indicated by the new symmetric key. In these embodiments, the neural network may not need to be re-trained based on the new symmetric key.

Notably, the steps of operations 400 described above are just some examples. In other embodiments, some of the steps may be omitted, additional steps may be added, or the order of the steps may be altered. Operations 400 are described for illustrative purposes and are not indicative of the total range of capabilities of, for example, model training engine 120 and key engine 120 of FIG. 1.

FIG. 5 depicts example operations 500 for using a neural network based on a symmetric key. For example, operations 500 may be performed by inference engine 150 of FIG. 1 after model 140 of FIG. 1 has been trained by model training engine 120 of FIG. 1 as described above with respect to operations 400 of FIG. 4.

Operations 500 begin at step 502, where a symmetric key is determined that indicates a scrambled ordering of data components. In some embodiments, inference engine 150 of FIG. 1 receives the symmetric key from key engine 110 of FIG. 1, and it is the same symmetric key used by model training engine 120 of FIG. 1 to train model 140 of FIG. 1.

Operations 500 then proceed to step 504, where a data item is received. In certain embodiments, inference engine 150 of FIG. 1 receives the data item from an application, such as application 204A of FIG. 2, along with a request to determine an inference based on the data item. The data item may, for example, be an image.

Operations 500 then proceed to step 506, a plurality of components of the data item are identified. For example, the plurality of components of the data item may be pixels of an image.

Operations 500 then proceed to step 508, where the plurality of components are provided to an input layer of a neural network based on the scrambled ordering indicated by the symmetric key. In some embodiments, inference engine 150 of FIG. 1 determines the scrambled ordering based on the symmetric key and provides the plurality of components to nodes of the input layer in the scrambled ordering.

Operations 500 then proceed to step 510, where an output is received from the neural network in response to the plurality of components. For example, model 140 of FIG. 1 may output an inference based on the plurality of components. In one example, the inference is a label indicating one or more entities present in an image. Inference engine 150 of FIG. 1 may receive the inference and, in some embodiments, provide the inference to a requesting application, such as application 204A of FIG. 2.

Notably, the steps of operations 500 described above are just some examples. In other embodiments, some of the steps may be omitted, additional steps may be added, or the order of the steps may be altered. Operations 500 are described for illustrative purposes and are not indicative of the total range of capabilities of, for example, inference engine 150 of FIG. 1.

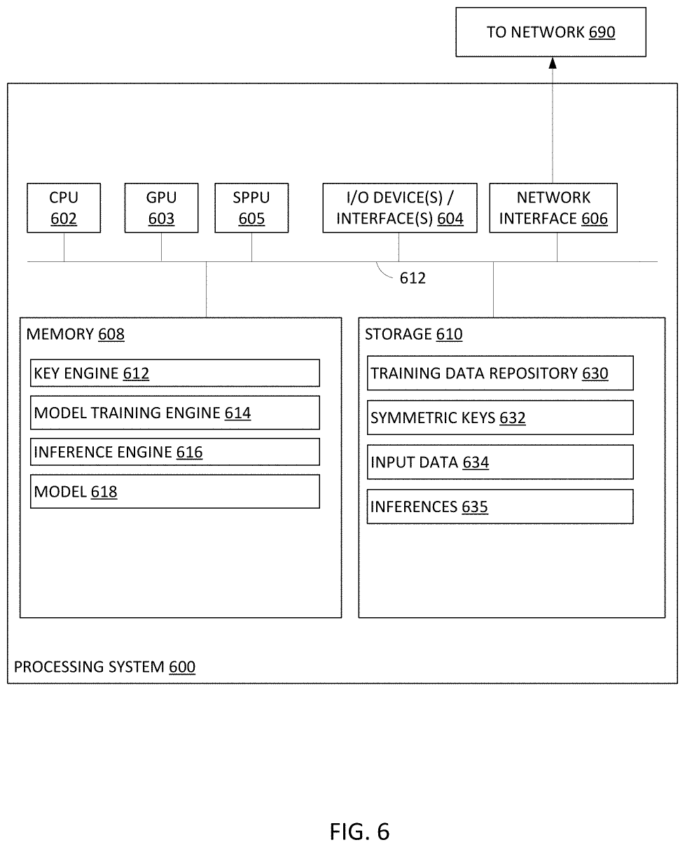

FIG. 6 depicts a processing system 600 that may be used to perform methods described herein, such as the operations for symmetric key encryption for neural network inputs described above with respect to FIGS. 4 and 5. In some embodiments, processing system is representative of one or more of nodes 732A, 732B, 732C, 742, and 744 of FIG. 7.

Processing system 600 includes a CPU 602, GPU 603 with associated GPU memory 650, and SPPU 605 all connected to a data bus 612. CPU 602, GPU 603, and SPPU 605 are configured to process computer-executable instructions, e.g., stored in memory 608, GPU memory 650, or storage 610, and to cause processing system 600 to perform methods as described herein, for example with respect to FIGS. 4 and 5. Though depicted as only including only one CPU 602, GPU 603, and SPPU 605, processing system 600 may have more than one of each type of processor. Further, in some implementations, processing system 600 may not have each type of processing unit. For example, another implementation of processing system 600 may only include CPU 602 and GPU 603. FIG. 6 is merely one example of a processing unit configured to execute the methods described herein.

Processing system 600 further includes input/output device(s) and interface(s) 604, which allows processing system 600 to interface with input/output devices, such as, for example, keyboards, displays, mouse devices, pen input, and other devices that allow for interaction with processing system 600. Note that while not depicted with independent external I/O devices, processing system 600 may connect with external I/O devices through physical and wireless connections (e.g., an external display device).

Processing system 600 further includes network interface 606, which provides processing system 600 with access to external networks, such as network 690, and thereby external computing devices.

Processing system 600 further includes memory 608, which in this example includes key engine 612, model training engine 614, inference engine 616, and model 618, which may be representative of key engine 110, model training engine 120, inference engine 150, and model 140 of FIG. 1.

Note that while shown as a single memory 608 in FIG. 6 for simplicity, the various aspects stored in memory 608 may be stored in different physical memories, but all accessible to CPU 602 via internal data connections, such as bus 612, or external data connections, such as network interface 606 or I/O device interfaces 604.

Processing system 600 further includes storage 610, which in this example includes training data repository 630, which may represent training data repository 130 of FIG. 1. Storage 610 further includes symmetric keys 632, input data 634, and inferences 635, as described above with respect to FIGS. 1-5.

While not depicted in FIG. 6, other aspects may be included in storage 610.

As with memory 608, a single storage 610 is depicted in FIG. 6 for simplicity, but the various aspects stored in storage 610 may be stored in different physical storages, but all accessible to CPU 602 via internal data connections, such as bus 612, I/O interfaces 604, or external connection, such as network interface 606.

### Example Distributed Computing Resource Management System in which Encryption for Neural Network Inputs May be Performed

FIG. 7 depicts an embodiment of a distributed computing resource management system 700 in which encryption for neural network inputs may be performed. For example, techniques described above with respect to FIGS. 1-6 may be implemented in distributed computing resource management system 200, such as on one or more of processing nodes 732A, 732B, 732C, 742, and 744.

Management system 700 includes an application repository 702. Application repository 702 stores and makes accessible applications, such as applications 704. Applications 704 may be deployed by system 700 on local and/or remote resources managed by management system 700, such as node 732A and container 744. In some examples, application repository 702 may act as an application marketplace for developers to market their applications.

Application repository 702 includes a software development kit (SDK) 706, which may include a set of software development tools that allows the creation of applications (such as applications 704) for a certain software package, software framework, hardware platform, computer system, video game console, operating system, or similar development platform. SDK 706 allows software developers to develop applications (such as applications 704), which may be deployed within management system 700, such as to nodes 732A, 732B, 732C, 742, and 744 and container 744. While only one container 744 is shown in management system 700, alternative embodiments include containers in various nodes, such as nodes 732A, 732B, 732C, and 744.

Some SDKs are critical for developing a platform-specific application. For example, the development of an Android app on Java platform requires a Java Development Kit, for iOS apps the iOS SDK, for Universal Windows Platform the .NET Framework SDK, and others. There are also SDKs that are installed in apps to provide analytics and data about activity. In some cases, and SDK may implement one or more application programming interfaces (APIs) in the form of on-device libraries to interface to a particular programming language, or to include sophisticated hardware that can communicate with a particular embedded system. Common tools include debugging facilities and other utilities, often presented in an integrated development environment (IDE). Note, though shown as a single SDK 706 in FIG. 7, SDK 706 may include multiple SDKs.

Management system 700 also includes system manager 708. System manager 708 may alternatively be referred to as the “system management core” or just the “core” of management system 700. System manager 708 includes many modules, including a node orchestration module 710, container orchestration module 712, workload orchestration module 714, application orchestration module 716, AI module 718, storage module 720, security module 722, and monitoring module 724. Notably, in other embodiments, system manager 708 may include only a subset of the aforementioned modules, while in yet other embodiments, system manager 708 may include additional modules. In some embodiments, various modules may be combined functionally.

Node orchestration module 710 is configured to manage nodes associated with management system 700. For example, node orchestration module 710 may monitor whether a particular node is online as well as status information associated with each node, such as what the processing capacity of the node is, what the network capacity of the node is, what type of network connection the node has, what the memory capacity of the node is (e.g., which may include GPU memory), what the storage capacity of the node is, what the battery power of the node is (if it is a mobile node not running on batter power), etc. Node orchestration module 710 may share status information with artificial intelligence (AI) module 718. Node orchestration module 710 may receive messages from nodes as they come online in order to make them available to management system 700 and may also receive status messages from active nodes in the system.

Node orchestration module 710 may also control the configuration of certain nodes according to predefined node profiles. For example, node orchestration module 710 may assign a node (e.g., 732A, 732B, 732C, 742, or 744) as a processing node, a storage node, a security node, a monitoring node, or other types of nodes.

A processing node may generally be tasked with data processing by management system 700. As such, processing nodes may tend to have high processing capacity and availability. Processing nodes may also tend to have more applications installed in their respective containers compared to other types of nodes. In some examples, processing nodes may be used for training models, such as complex machine learning models, including neural network and deep learning models. For instance, nodes 732A, 7322C, and 744 may be processing nodes, any of which may run aspects of model 140 (described above with respect to FIG. 1).

A storage node may generally be tasked with data storage. As such, storage nodes may tend to have high storage availability. In some cases, a storage node may have a large amount of underutilized GPU memory.

A security node may be tasked with security related tasks, such as monitoring activity of other nodes, including nodes in common sub-pool of resources, and reporting that activity back to security module 722. A security node may also have certain, security related types of applications, such as virus scanners, intrusion detection software, etc.

A monitoring node may be tasked with monitoring related tasks, such as monitoring activity of other nodes, including nodes in a common sub-pool of resources, and reporting that activity back to node orchestration module 710 or monitoring module 724. Such activity may include the nodes availability, the nodes connection quality, and other such data.

Not all nodes need to be a specific type of node. For example, there may be general purpose nodes that include capabilities associated with one or more of processing, storage, security, and monitoring. Further, there may be other specific types of nodes, such as machine learning model training or execution nodes. Node 732B may, for instance, be a general purpose node, as it includes training data repository 130 (e.g., storage functionality) and model training engine 120 (e.g., processing functionality), which are described above with respect to FIG. 1. Alternatively, node 732B may be a machine learning model training node. In some embodiments, node 744 is a machine learning model execution node, as it runs model 140.

Container orchestration module 712 manages the deployment of containers to various nodes, such as container 744 to node 742. For example, container orchestration module 712 may control the installation of containers in nodes, such as 732A, which are known to management system 700, but which do not yet have containers. In some cases, container orchestration module 712 may interact with node orchestration module 710 and/or monitoring module 724 to determine the status of various containers on various nodes associated with system 700.

Workload orchestration module 714 is configured to manage workloads distributed to various nodes, such as nodes 732A, 732B, 732C, 742, or 744. For example, when a job is received by management system 700, for example by way of interface 750, workload orchestration module 714 may distribute the job to one or more nodes for processing. In particular, workload orchestration module 714 may receive node status information from node orchestration module 710 and distribute the job to one or more nodes in such a way as to optimize processing time and maximize resources utilization based on the status of the nodes connected to the system.

In some cases, when a node becomes unavailable (e.g., goes offline) or becomes insufficiently available (e.g., does not have adequate processing capacity), workload orchestration module 714 will reassign the job to one or more other nodes. For example, if workload orchestration module 714 had initially assigned the job of running key engine 110 to node 732A, but then node 732A went offline, then workload orchestration module 714 may reassign the job to node 732B. In some cases, the reassignment of a job may include the entire job, or just a portion of a job that was not yet completed by the original assigned node.

In another example, if workload orchestration module 714 had initially allocated storage to a GPU of node 732A, and the GPU of node 732A then becomes busy, then workload orchestration module 714 may reallocate the memory space to a different node (e.g., to a GPU of node 732B).

Workload orchestration module 714 may also provide splitting (or chunking) operations. Splitting or chunking is the act of breaking a large processing job down in to small parts that can be processed by multiple processing nodes at once (i.e., in parallel). Notably, workload orchestration may be handled by system manager 708 as well as by one or more nodes. For example, an instance of workload orchestration module 714 may be loaded onto a node to manage workload within a sub-pool of resources in a peer-to-peer fashion in case access to system manager 708 is not always available.

Workload orchestration module 714 may also include scheduling capabilities. For example, schedules may be configured to manage computing resources (e.g., nodes 732A, 732B, 732C, 742, or 744) according to custom schedules to prevent resource over-utilization, or to otherwise prevent interruption with a node's primary purpose (e.g., being an employee workstation).

In one example, a node may be configured such that it can be used by system 700 only during certain hours of the day. In some cases, multiple levels of resource management may be configured. For example, a first percentage of processing resources at a given node may be allowed during a first time interval (e.g., during working hours) and a second percentage of processing resources may be allowed during a second time interval (e.g., during non-working hours). In this way, the nodes can be configured for maximum resource utilization without negatively affecting end-user experience with the nodes during regular operation (i.e., operation unrelated to system 700). In some cases, schedules may be set through interface 750.

In another example, a first percentage of memory resources at a given node may be allowed during a first time interval (e.g., during working hours) and a second percentage of memory resources may be allowed during a second time interval (e.g., during non-working hours). In this way, the nodes can be configured for maximum resource utilization without negatively affecting end-user experience with the nodes during regular operation (i.e., operation unrelated to system 700). In some cases, schedules may be set through interface 150.

In the example depicted in FIG. 7, workload orchestration module 714 is a part of system manager 708, but in other examples an orchestration module may be resident on a particular node, such as node 732A, to manage the resident node's resources as well as other node's resources in a peer-to-peer management scheme. This may allow, for example, jobs to be managed by a node locally while the node moves in and out of connectivity with system manager 708. In such cases, the node-specific instantiation of a node orchestration module may nevertheless be a “slave” to the master node orchestration module 710.

In some embodiments, workload orchestration module 714 includes inference engine 150 and/or model training engine 120 of FIG. 1.

Application orchestration module 716 manages which applications are installed in which containers or on which nodes, such as container 744 and nodes 732A, 732B, 732C, 742, or 744. For example, workflow orchestration module 714 may assign a job to a node that does not currently have the appropriate application installed to perform the job. In such a case, application orchestration module 716 may cause the application to be installed in the container from, for example, application repository 702. In one example, application orchestration module 716 causes inference engine 150 to be installed on 732C in order to perform processing related to use of model 140 to determine inferences, which may be functionality requested by another application running on another node, such as an application that involves image recognition.

Application orchestration module 716 is further configured to manage applications once they are installed on nodes or in containers. For example, application orchestration module 716 may enable or disable applications installed in containers, grant user permissions related to the applications, and grant access to resources. Application orchestration module 716 enables a software developer to, for example, upload new applications, remove applications, manage subscriptions associated with applications, and receive data regarding applications (e.g., number of downloads, installs, active users, etc.) in application repository 702, among other things.

Like workload orchestration module 714, in some cases application orchestration module 716 may be installed on a particular node to manage deployment of applications in a cluster of nodes. As above, this may reduce reliance on system manager 708 in situations such as intermittent connectivity. And as with the workload orchestration module 714, a node-specific instantiation of an application orchestration module may be a slave to a master application orchestration module 716 running as part of system manager 708.

AI module 718 may be configured to interact with various aspects of management system 700 (e.g., node orchestration module 710, container orchestration module 712, workload orchestration module 714, application orchestration module 716, storage module 720, security module 722, and monitoring module 724) in order to optimize the performance of management system 700. For example, AI module 718 may monitor performance characteristics associated with various nodes and feedback workload optimizations to workload orchestration module 714. Likewise, AI module 718 may monitor network activity between various nodes to determine aberrations in the network activity and to thereafter alert security module 722.

AI module 718 may include a variety of machine-learning models in order to analyze data associated with management system 700 and to optimize its performance. AI module 718 may further include data preprocessing and model training capabilities for creating and maintaining machine learning models.

Storage module 720 may be configured to manage storage nodes associated with management system 700. For example, storage module 720 may monitor status of storage allocations, both long-term and short-term, within management system 700. In some cases, storage module 720 may interact with workload orchestration module 714 in order to distribute data associated with jobs, or portions of jobs to various nodes for short-term or long-term storage. In some cases, storage module 720 may allocate memory to be used by workload orchestration module 714. Further, storage module 720 may report such status information to application orchestration module 716 to determine whether certain nodes have enough memory and/or storage available for certain applications to be installed on those nodes. Storage information collected by storage module 720 may also be shared with AI module 718 for use in system optimization.

Security module 722 may be configured to monitor management system 700 for any security breaches, such as unauthorized attempts to access containers, unauthorized job assignment, etc. Security module 722 may also manage secure connection generation between various nodes (e.g., 732A, 732B, 732C, 742, or 744) and system manager 708. In some cases, security module 722 may also handle user authentication, e.g., with respect to interface 750. Further, security module 722 may provide connectivity back to enterprise security information and event management (SIEM) software through, for example, application programming interface (API) 726. In some embodiments, security module generates keys 784 for storage in key repository 780. For example, key engine 110 of FIG. 1 may be included in security module 722.

In some cases, security module 722 may observe secure operating behavior in the environment and make necessary adjustments if a security situation is observed. For example, security module 722 may use machine learning, advanced statistical analysis, and other analytic methods to flag potential security issues within management system 700.

Monitoring module 724 may be configured to monitor the performance of management system 700. For example, monitoring module 724 may monitor and record data regarding the performance of various jobs (e.g., how long the job took, how many nodes were involved, how much network traffic the job created, what percentage processing capacity was used at a particular node, what percentage of memory capacity was used, and others.

Monitoring module 724 may generate analytics based on the performance of system 700 and share them with other aspects of management system 700. For example, monitoring module 724 may provide the monitoring information to AI module 718 to further enhance system performance. As another example, the analytics may be displayed in interface 750 so a system user may determine system performance and potentially change various parameters of system 700. In other embodiments, there may be a separate analytics module (not depicted) that is focused on the generation of analytics for system 700.

Monitoring module 724 may also provide the monitoring data to interface 750 in order to display system performance metrics to a user. For example, the monitoring data may be useful to report key performance indicators (KPIs) on a user dashboard.

Application programming interface (API) 726 may be configured to allow any of the aforementioned modules to interact with nodes (e.g., 732A, 732B, 732C, 742, or 744) or containers (e.g., 744). Further, API 726 may be configured to connect third-party applications and capabilities to management system 700. For example, API 726 may provide a connection to third-party storage systems, such as AMAZON S3®, EGNYTE®, and DROPBOX®, among others.

Management system 700 includes a pool of computing resources 760. The computing resources include on-site computing resources 730, which may include all resources in a particular location (e.g., a building). For example, an organization may have an office with many general purpose computing resources, such as desktop computers, laptop computers, servers, and other types of computing resources as well. Each one of these resources may be a node into which a container and/or applications may be installed.

Resource pool 760 may also include off-site computing resources 740, such as remote computers, servers, etc. Off-site computing resources 740 may be connected to management system 700 by way of network connections, such as a wide area network connection (e.g., the Internet) or via a cellular data connection (e.g., LTE, 5G, etc.), or by any other data-capable network. Off-site computing resources 740 may also include third-party resources, such as cloud computing resource providers, in some cases. Such third-party services may be able to interact with management system 700 by way of API 726. Because off-site computing resources 740 may not be under the exclusive control of an organization associated with on-site computing resources 730, security may be a higher concern for off-site computing resources 740. As such, techniques described herein for using symmetric keys to scramble inputs to a model, such as model 140 on node 744, may be particularly advantageous when providing sensitive data as inputs to a model running on off-site computing resources 740.

Nodes 732A, 732B, 732C, 742, and 744 may be any sort of computing resource that is capable of having a container and/or an application installed on it. For example, nodes 732A, 732B, 732C, 742, and 744 may be desktop computers, laptop computers, tablet computers, smartphones, other smart devices, servers, gaming consoles, or any other sort of computing device. In many cases, nodes 732A, 732B, 732C, 742, and 744 will be general purpose computing devices.

Management system 700 includes model repository 770. Model repository 770 includes model data 772, which may include data relating to trained models (including parameters), training data, validation data, model results, and others. Model repository 770 also includes training tools 774, which may include tools, SDKs, algorithms, hyperparameters, and other data related to training models, such as machine learning models, including neural network and deep learning models. Model repository 770 also includes model parameter manager 776, which interfaces with system manager 708 to manage model parameters when system manager 708 has distributed model training across a plurality of nodes, such as nodes 732A, 732B, 732C, 742, and 744. In some embodiments, data in model repository 770 is used by model training engine 120 and/or inference engine 150 of FIG. 1 when training and/or using model 140, which may be stored in model repository 770.

Key repository 780 generally stores keys 784, which may include symmetric key 112 of FIG. 1 and/or symmetric key 210 of FIG. 2.

Management system 700 includes node state database 728, which stores information regarding nodes in resource pool 760, including, for example, hardware configurations and software configurations of each node, which may be referred to as static status information. Static status information may include configuration details such as CPU and GPU types, clock speed, memory size and type (e.g., general system memory or GPU memory), disks available, network interface capability, firewall presence and settings, proxy and other server configuration (e.g., HTTP), presence and configuration of NTP servers, type and version of the operating system, applications installed on node, etc. In general, static status information comprises configuration information about a node that is not transient.

Node state database 728 may also store dynamic information regarding nodes in resource pool 760, such as the usage state of each node (e.g., power state, network connectivity speed and state, percentage of CPU and/or GPU usage, including usage of specific cores, percentage of memory usage, active network connections, active network requests, network status, network connections rate, service usages (e.g., SSH, VPN, DNS, etc.), networking usage (sockets, packets, errors, ICMP, TCP, UDP, explicit congestion notification, etc.), usage alerts and alarms, stats with quick refresh rate, synchronization, machine utilization, system temperatures, and machine learning analytics (e.g., using graphs, heat maps, and geological dashboards), availability of unused resources (e.g., for rent via a system marketplace), etc.). In general, dynamic status information comprises transient operational information about a node, though such information may be transformed into representative statistical data, such as averages (e.g., average percentage of CPU and/or GPU processing and/or memory use, etc.).

In this example node state database 728 is shown separate from system manager 708, but in other embodiments node state database 728 may be another aspect of system manager 708.

Interface 750 provides a user interface for users to interact with system manager 708. For example, interface 750 may provide a graphical user interface (e.g., a dashboard) for users to schedule jobs, check the status of jobs, check the status of management system 700, configure management system 700, etc.

It is noted that management system 700 is included as one example of a computing environment in which embodiments of the present disclosure may be implemented. Alternatively, techniques described herein for symmetric key encryption for neural network inputs may be performed in other computing environments.

The preceding description provides examples, and is not limiting of the scope, applicability, or embodiments set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The preceding description is provided to enable any person skilled in the art to practice the various embodiments described herein. Various modifications to these embodiments will be readily apparent to those skilled in the art, and the generic principles defined herein may be applied to other embodiments. For example, changes may be made in the function and arrangement of elements discussed without departing from the scope of the disclosure. Various examples may omit, substitute, or add various procedures or components as appropriate. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

A processing system may be implemented with a bus architecture. The bus may include any number of interconnecting buses and bridges depending on the specific application of the processing system and the overall design constraints. The bus may link together various circuits including a processor, machine-readable media, and input/output devices, among others. A user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer-readable medium. Software shall be construed broadly to mean instructions, data, or any combination thereof, whether referred to as software, firmware, middleware, microcode, hardware description language, or otherwise. Computer-readable media include both computer storage media and communication media, such as any medium that facilitates transfer of a computer program from one place to another. The processor may be responsible for managing the bus and general processing, including the execution of software modules stored on the computer-readable storage media. A computer-readable storage medium may be coupled to a processor such that the processor can read information from, and write information to, the storage medium. In the alternative, the storage medium may be integral to the processor. By way of example, the computer-readable media may include a transmission line, a carrier wave modulated by data, and/or a computer readable storage medium with instructions stored thereon separate from the wireless node, all of which may be accessed by the processor through the bus interface. Alternatively, or in addition, the computer-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module, it will be understood that such functionality is implemented by the processor when executing instructions from that software module.

The following claims are not intended to be limited to the embodiments shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method for training a neural network, comprising:
determining a symmetric key that indicates a scrambled ordering of data components;
receiving a plurality of training data instances; and
training a neural network by, for each respective training data instance of the plurality of training data instances:
identifying a training input and a training output of the respective training data instance;
identifying a plurality of training input components of the training input;
providing the plurality of training input components to an input layer of the neural network based on the scrambled ordering indicated by the symmetric key;
receiving an output from the neural network in response to the plurality of training input components; and
determining whether to modify one or more parameters of the neural network based on the output and the training output of the respective training data instance.

2. The method of claim 1, wherein a length of the symmetric key is determined based on a number of components of the input layer of the neural network.

3. The method of claim 1, wherein providing the plurality of training input components to the input layer of the neural network based on the scrambled ordering indicated by the symmetric key comprises scrambling the plurality of training input components by applying the symmetric key to subsets of the plurality of training input components.

4. The method of claim 1, wherein, after the neural network is trained, the symmetric key is used to determine an order in which to provide input components to the input layer of the neural network.

5. The method of claim 1, wherein determining the symmetric key comprises verifying a security level of the symmetric key by:
scrambling a sample input using the symmetric key to produce a scrambled sample input; and
providing the scrambled sample input to a security verification component that attempts to determine the sample input based on the scrambled sample input without using the symmetric key.

6. The method of claim 1, further comprising distributing the neural network to a plurality of processing components, wherein the symmetric key is not provided to the plurality of processing components.

7. The method of claim 1, further comprising:
determining a new symmetric key that indicates a new scrambled ordering; and
re-training the neural network based on the new symmetric key and the plurality of training data instances.

8. The method of claim 1, further comprising generating the input layer of the neural network based on the symmetric key, wherein respective components of the input layer are mapped to components of an additional input layer of the neural network based on the symmetric key.

9. The method of claim 8, further comprising:
determining a new symmetric key that indicates a new scrambled ordering; and
modifying the input layer of the neural network based on the new symmetric key.

10. An apparatus, comprising:
a memory comprising computer-executable instructions; and
a processor in data communication with the memory and configured to execute the computer-executable instructions and cause the apparatus to perform a method for training a neural network, the method comprising:
determining a symmetric key that indicates a scrambled ordering of data components;
receiving a plurality of training data instances; and
training a neural network by, for each respective training data instance of the plurality of training data instances:
identifying a training input and a training output of the respective training data instance;
identifying a plurality of training input components of the training input;
providing the plurality of training input components to an input layer of the neural network based on the scrambled ordering indicated by the symmetric key;
receiving an output from the neural network in response to the plurality of training input components; and
determining whether to modify one or more parameters of the neural network based on the output and the training output of the respective training data instance.

11. The apparatus of claim 10, wherein a length of the symmetric key is determined based on a number of components of the input layer of the neural network.

12. The apparatus of claim 10, wherein providing the plurality of training input components to the input layer of the neural network based on the scrambled ordering indicated by the symmetric key comprises scrambling the plurality of training input components by applying the symmetric key to subsets of the plurality of training input components.

13. The apparatus of claim 10, wherein, after the neural network is trained, the symmetric key is used to determine an order in which to provide input components to the input layer of the neural network.

14. The apparatus of claim 10, wherein determining the symmetric key comprises verifying a security level of the symmetric key by:
scrambling a sample input using the symmetric key to produce a scrambled sample input; and
providing the scrambled sample input to a security verification component that attempts to determine the sample input based on the scrambled sample input without using the symmetric key.

15. The apparatus of claim 10, wherein the method further comprises distributing the neural network to a plurality of processing components, wherein the symmetric key is not provided to the plurality of processing components.

16. The apparatus of claim 10, wherein the method further comprises:
determining a new symmetric key that indicates a new scrambled ordering; and
re-training the neural network based on the new symmetric key and the plurality of training data instances.

17. The apparatus of claim 10, wherein the method further comprises generating the input layer of the neural network based on the symmetric key, wherein respective components of the input layer are mapped to components of an additional input layer of the neural network based on the symmetric key.

18. The apparatus of claim 17, wherein the method further comprises:
determining a new symmetric key that indicates a new scrambled ordering; and
modifying the input layer of the neural network based on the new symmetric key.

19. A non-transitory computer-readable medium comprising instructions that, when executed by one or more processors of a computing system, cause the computing system to perform a method for training a neural network, the method comprising:
determining a symmetric key that indicates a scrambled ordering of data components;
receiving a plurality of training data instances; and
training a neural network by, for each respective training data instance of the plurality of training data instances:
identifying a training input and a training output of the respective training data instance;
identifying a plurality of training input components of the training input;
providing the plurality of training input components to an input layer of the neural network based on the scrambled ordering indicated by the symmetric key;
receiving an output from the neural network in response to the plurality of training input components; and
determining whether to modify one or more parameters of the neural network based on the output and the training output of the respective training data instance.

20. The non-transitory computer-readable medium of claim 19, wherein a length of the symmetric key is determined based on a number of components of the input layer of the neural network.
